(19) United States
(12) Patent Application Publication
(10) Pub. No.: US 2023/0128735 A1
(43) Pub. Date: Apr. 27, 2023

(54) Device for Determining the Temperature of an Object

(71) Applicant: Schlaeger Kunststofftechnik GmbH, Bayreuth (DE)

(72) Inventor: Anton Fuchs, Rückersdorf (DE)

(21) Appl. No.: 17/798,714

(22) PCT Filed: Feb. 12, 2021
(86) PCT No.: PCT/EP2021/053567

§ 371 Date: Aug. 10, 2022

(30) Foreign Application Priority Data
Feb. 14, 2020 (DE) 10 2020 103 915.8

(51) Int. Cl. G01K 1/16; G01K 1/20; G01K 1/143

(52) U.S. Cl. CPC G01K 1/16; G01K 1/20; G01K 1/143; G01K 2205/00

(57) ABSTRACT

A device for determining the temperature of an object includes a main body with an interior space delimited by walls for receiving an object, the temperature of which is to be determined, wherein at least one determination element configured to determine the temperature is arranged or formed within at least one wall, and also at least one thermally conductive contact element which is arranged or formed on or in the wall within which the determination element is arranged or formed.

The invention relates to a device for determining the temperature of an object, wherein the device comprises a main body with an interior space delimited by walls for receiving the object, wherein at least one determination element configured to determine the temperature is arranged or formed within at least one wall.

Corresponding devices, sometimes also referred to as sensor arrangements, are known in principle from the prior art in various embodiments. Such devices comprise a main body defined by walls. The walls of the main body delimit an interior space which is configured to receive an object of which the temperature is to be determined. A determination element, typically formed as a temperature sensor or comprising such a sensor, is arranged or formed here within at least one wall.

The fact that there is typically, due to the design, no direct contact and thus poor heat transfer between the object in question and the determination element can affect the accurate determination of the temperature of the object.

Against this background, there is a need for an improved device for determining the temperature of an object, in particular with regard to the thermal connection between a corresponding object and a corresponding determination element.

The object of the invention is to provide an improved device for determining the temperature of an object, in particular a device that is improved with regard to the thermal connection between a corresponding object and a corresponding determination element.

The object is achieved by a device according to claim 1. The claims dependent thereon concern possible embodiments of the device.

A first aspect of the invention relates to a device for determining the temperature of an object. The device is thus configured to determine the temperature of an object. The device may also be referred to as or deemed to be a sensor arrangement, i.e. in particular a temperature sensor arrangement.

The object for which the temperature is to be determined by means of the device may be formed of or may comprise a thermally conductive material, such as a metal, or a thermally conductive material structure, such as a metal structure. The object may have a rod-like or rod-shaped geometric-constructive form. The object may therefore be, for example, a rod made of metal.

The object is typically thermally coupleable or coupled to a heat source via which the object is temperature-controllable or temperature-controlled. The temperature of the object is thus determined in essence by the amount of heat introducible into the object via the heat source thermally coupleable or coupled to the object. The heat source may vary depending on the application of the device. For the example of an application of the device in a vehicle, i.e. in particular in a motor vehicle, such as a passenger car, the heat source may be a heat source on the (motor) vehicle side.

Alternatively or additionally, the object is coupleable or coupled to a current and/or voltage source. In particular, the object may be couplable or coupled to a high-voltage source; thus, a high voltage, i.e. in particular a voltage above 1 kV, may be applied to the object. For the example of an application of the device in a vehicle, i.e. in particular in a motor vehicle, such as a passenger car, the current and/or voltage source may be a current and/or voltage source on the (motor) vehicle side.

The heat source may be identical to the current and/or voltage source, and vice versa.

The device comprises a main body. The main body may also be referred to or considered as the housing part of the device. The main body has one or more walls or is defined by one or more walls. The one or more walls delimit at least one interior space for receiving an object for which the temperature is to be determined by means of the device. The main body may therefore have a hollow-cylinder-like or hollow-cylinder-shaped basic geometric form. The geometric-constructive properties, i.e. in particular dimensions, shape, etc., of the interior space are typically adapted to the geometric-constructive properties, i.e. in particular dimensions, shape, etc., of the object that is to be received or is received therein, so that an object is receivable as accurately as possible in the interior space. As will be seen in the following, a corresponding object is receivable or received in the interior space with a certain amount of play, in particular due to high manufacturing tolerances.

The main body of the device is typically an injection-moulded part. The main body is therefore typically formed from an injection-mouldable or injection-moulded plastics material. In particular, injection-mouldable plastics materials with a high electrical and/or thermal stability, i.e. in particular high-performance plastics materials, come into consideration. Merely by way of example, reference is made to polyamide imide (PAI), polyether ether ketone (PEEK), polyphenylene sulphide (PPS), polyphenyl sulphone (PPSU), polyimide (PI), or polyphthalamide (PPA). Of course, mixtures of chemically different plastic materials are conceivable.

If the device is a particularly small component assembly, such as a precision component assembly, the main body may be a micro-injection-moulded part.

At least one wall of the main body can divide the interior space into two interior space regions. A corresponding wall may in particular be web-like or web-shaped and may extend into the interior space from another wall, such as a wall forming a base of the main body; the interior space may thus be divided into at least two interior space regions by a corresponding wall extending in a web-like or web-shaped manner into the interior space from another wall, such as a wall forming a base of the main body. In this case, at least one interior space region can be configured to receive a corresponding object; the above explanations in conjunction with the receiving of an object in the interior space thus apply analogously to a corresponding interior space region.

A correspondingly web-like or web-shaped wall may have a ramp-like or ramp-shaped design at least on one side in the region of its free end. In this way, for example, an object to be received in the interior space can be easily inserted into the interior space.

At least one determination element configured to determine a temperature is arranged or formed within at least one wall of the main body. At least one wall is therefore provided with at least one determination element configured for determining a temperature. The determination element is typically captively arranged or formed within the wall in question. The determination element is therefore surrounded or enclosed, in particular completely, by the material forming the wall. This can be realised, for example, by the fact that the determination element is overmoulded with a material forming the wall or is arranged or formed in a receiving space provided for this purpose within the wall. In particular, the determination element can be arranged or formed within a corresponding wall that divides the interior space into two interior space regions.

The determination element may be formed as or may comprise a temperature sensor. A corresponding temperature sensor, for example, may be formed as or may comprise a thermistor. A corresponding thermistor may, for example, be formed as an NTC element (negative temperature coefficient thermistor) or may comprise such an element.

The device comprises at least one thermally conductive contact element that can be brought or is brought into thermal contact with an object that is receivable or received in the interior space. The contact element is arranged or formed on or in the wall within which the determination element is arranged or formed. The contact element is thus arranged or formed, in particular in thermal terms, between an object that is receivable or is received in the interior space and the contact element arranged or formed within the wall. The contact element thus enables improved heat transfer between an object that is receivable or is received in the interior space and the determination element arranged or formed within the wall. The contact element can thus form a thermal bridge between an object that is receivable or is received in the interior space and the determination element arranged or formed within the wall, so that, although there is typically no direct contact between the object and the determination element arranged or formed within the wall, the heat transfer between the object and the determination element arranged or formed within the wall is (considerably) improved.

The contact element may be formed of or may comprise a thermally conductive metal, such as copper. Alternatively or additionally, the contact element may be formed of or may comprise a thermally conductive metal structure, such as a copper structure. In principle, designs of the contact element made of other thermally conductive materials or material structures are also conceivable; for example, reference should be made to plastics materials filled with thermally conductive particles, such as graphite particles.

Overall, an improved device for determining the temperature of an object is provided.

The contact element is typically arranged or formed on the wall adjacently to the determination element arranged or formed within the wall. A corresponding adjacent arrangement allows a good heat transfer from the contact element to the determination element. Depending on the arrangement and/or orientation of the main body or the contact element, an adjacent arrangement can be understood to mean, for example, a lateral arrangement and/or orientation of the contact element relative to the determination element, an arrangement and/or orientation of the contact element above the determination element, or an arrangement and/or orientation of the contact element below the determination element.

As mentioned, there is typically no direct contact between the object and the determination element arranged or formed within the wall. Similarly, there is typically also no direct contact between the contact element and the determination element arranged or formed within the wall. The determination element can thus be electrically insulated with respect to the contact element, in particular due to its arrangement or formation within the wall. The arrangement or design of the determination element within the wall can thus provide electrical insulation of the determination element with respect to the contact element, so that any electrical currents and/or voltages present at the contact element cannot be transmitted to the determination element. The electrical insulation of the determination element with respect to the contact element can be configured for voltage ranges above 500 V, in particular above 1 kV.

The contact element can be arranged or formed movably mounted in at least one degree of freedom of movement on or in the wall within which the determination element is arranged or formed. The arrangement or design of the contact element, which is movably mounted in at least one degree of freedom of movement, can serve, for example, to compensate for manufacturing tolerances of the object that is to be received or is received in the interior space and/or to facilitate the introduction of an object to be received in the interior space into the interior space. Moreover, the arrangement or design of the contact element, which is movably mounted in at least one degree of freedom of movement, typically enables contact between the contact element and an object received in the interior space to be made over as large an area as possible; this is particularly the case because the orientation and/or position of the contact element can be adapted to the alignment and/or position of an object that is to be received or is received in the interior space due to its movable mounting.

A corresponding degree of freedom of movement of the contact element may basically be a translational and/or a rotational degree of freedom of movement. The contact element can thus be moved translationally along a translation axis by a certain amount, in particular relative to a reference orientation and/or position of the contact element, and/or rotationally about a rotation axis by a certain amount, in particular relative to a reference orientation and/or position of the contact element. In a specific embodiment, the contact element can, for example, be tilted or pivoted by a certain amount about a tilt or swivel axis.

The contact element can have a first surface portion which has at least one surface (first surface) with a geometry corresponding to an outer geometry of an object that is to be received or is received in the receiving space. The first surface faces the object received in the interior space in the operating state of the device in which an object is received in the interior space. The first surface portion can therefore have a surface with a geometry corresponding to the outer geometry of an object that is to be received or is received in the receiving space. A corresponding surface with a geometry corresponding to the outer geometry enables the contact element to lie flat against an object that is to be received or is received in the interior space and thus a good heat transfer from the object to the contact element.

In a specific embodiment, the contact element can therefore have, for example, a first surface portion which has at least one flat or planar, i.e. not curved or arched, surface (first surface). The flat or planar surface of the first surface portion can have a plate-like or plate-shaped basic geometric form. The first surface portion enables the contact element to lie flat against an object with a flat or planar outer geometry that is received in the interior space, and thus enables good heat transfer from the object to the contact element. The first surface portion may therefore have a flat or planar surface which, in the operating state of the device, in which an object is received in the interior space, faces the object received in the interior space. The flat or planar surface of the first surface portion can, for example, be oriented running parallel to an exposed outer wall of the main body. As will be seen further, the first surface portion typically also has a surface (second surface) which, in the operating state of the device, in which an object is received in the interior space, faces away from the object received in the interior space and faces the determination element. The second surface is typically arranged opposite the first surface.

The first surface portion can therefore, in the operating state of the device in which an object is received in the interior space, form with a surface facing the wall within which the determination element is arranged or formed (second surface) a, in particular one-dimensional or multi-dimensional, i.e. in particular linear or laminar, support or contact region for supporting the contact element on the wall or for contacting the contact element with the wall. The second surface can be equally flat or planar, i.e. not curved or arched; however, this is not absolutely necessary, and therefore—irrespective of the flat or planar design of the first surface—an at least partially curved or arched design of the second surface is conceivable.

The contact element can have at least one further surface portion oriented running at an angle, in particular at right angles, to the first surface portion. In particular, the contact element can have at least two further surface portions each oriented at an angle, in particular at right angles, to the first surface portion. The contact element can thus have a U-like or U-shaped basic geometric form when viewed in cross-section. If the contact element has at least two corresponding further surface portions, these can be arranged or formed parallel to one another. The contact element can therefore represent a three-dimensional component extending in several different spatial directions, wherein—as will be shown in more detail below—the first and further surface portions can be functionalised differently.

A corresponding further surface portion can, for example, have a web-like or web-shaped basic geometric form; ring-like or ring-shaped basic geometric forms are also conceivable.

The at least one further surface portion may form a fastening region for fastening the contact element to or in the wall within which the determination element is arranged or formed. A function of a corresponding further surface portion can therefore be a fastening function which allows the contact element to be fastened to the wall. Depending on the geometric-constructive design of the further surface portion, form-fitting and/or frictionally engaged and/or integrally bonded fastenings of the contact element to the wall can be considered; specifically, a corresponding further surface portion can be provided, for example, with form-fit and/or frictional engagement elements which enable a form-fitting and/or frictionally engaged fastening of the contact element to the wall. Corresponding form-fit and/or frictional engagement elements can be or comprise, for example, optionally undercut, latching or snap-in elements, threaded elements, etc.

A fastening of the contact element to the wall within which the determination element is arranged or formed can be realised, for example, in that the contact element can be fastened to the wall at least in portions in a form-fitting and/or frictionally engaged and/or integrally bonded manner. According to a specific example, the contact element can surround the wall on the outside at least in portions, if necessary completely. In principle, adhesive, clamping, snap-in, welding or tensioning fastenings are possible for fastening the contact element to the wall.

A fastening of the contact element in the wall within which the determination element is arranged or formed can be realised, for example, in that the contact element engages, at least in portions, in a form-fitting and/or frictionally engaged and/or integrally bonded manner in at least one, in particular recess-like or recess-shaped, receiving region in the wall. Accordingly, at least one, in particular recess-like or recess-shaped, receiving or engagement region for receiving or engaging the at least one further surface portion can be arranged or formed in the wall within which the determination element is arranged or formed. The receiving region may correspondingly form a fastening region or may comprise such a region, which cooperates with a corresponding further surface portion received therein to form a fastening of the contact element to or in the wall. Accordingly, the receiving region can be provided, for example, with form-fit and/or frictional engagement elements which enable a form-fitting and/or frictionally engaged fastening of the contact element to or in the wall. Corresponding form-fit and/or frictional engagement elements may be or may comprise, for example, possibly undercut, latching or snap-in elements, threaded elements, etc.

At this point, it should be noted in general that the contact element can be arranged or formed, i.e. in particular fastened, in such a way that it is arranged or formed in principle non-releasably or releasably (without damage or destruction) on or in the wall within which the determination element is arranged or formed.

The at least one further surface portion can be dimensioned, in particular with regard to its longitudinal extension, in such a way that it surrounds or engages at least in portions around the determination element arranged or formed within the wall. Correspondingly, a corresponding receiving region, in particular with regard to its longitudinal extension, in the wall can be dimensioned in such a way that a further surface portion received therein surrounds or engages at least in portions around the determination element arranged or formed within the wall. The determination element can therefore be surrounded or engaged around by the contact element from at least two sides, i.e. on the one hand via the first surface portion and on the other hand via the at least one further surface portion. In this way, it is possible that heat transmitted to the contact element via an object received in the interior space can be transmitted to the determination element not only via the first surface portion, but also via one or more further surface portions surrounding or engaging around the determination element, in particular laterally. The heat transfer between the contact element and the determination element can be improved in this way.

In principle, other geometric-constructive designs of the contact element are also conceivable as an alternative to the described embodiment of the contact element with a first and at least one further surface portion. For example, a winding-like or winding-shaped design of the contact element is conceivable; consequently, the wall within which the determination element is arranged or formed could be wrapped with the contact element at least in portions, if necessary completely.

It is true for all embodiments that the device can comprise an evaluation device implemented in terms of hardware and/or software for evaluating signals supplied by the determination element with regard to at least one evaluation criterion. In particular, the evaluation device can be configured to evaluate corresponding signals supplied by the determination element with regard to the temperature of an object recorded in the interior space. The evaluation device is connectable or is connected to the determination element in terms of signals, so that signals supplied by the determination element can be transmitted to the evaluation device.

A second aspect of the invention relates to a vehicle, i.e. in particular a motor vehicle, such as a passenger car, comprising a device according to the first aspect of the invention.

A third aspect of the invention relates to a method for producing a device for determining the temperature of an object, in particular a device according to the first aspect of the invention. The method is characterised by the following steps:
forming or providing a main body with an interior space delimited by walls for receiving the object, wherein at least one determination element configured for determining the temperature is arranged or formed within at least one wall,
arranging or forming at least one thermally conductive contact element, which can be brought into thermal contact with an object received in the interior space, on or in the wall within which the determination element is arranged or formed.

All explanations in conjunction with the device according to the first aspect of the invention apply analogously for the vehicle according to the second aspect of the invention and for the method according to the third aspect of the invention.

The invention will be explained in more detail with the aid of exemplary embodiments in the drawings, in which:

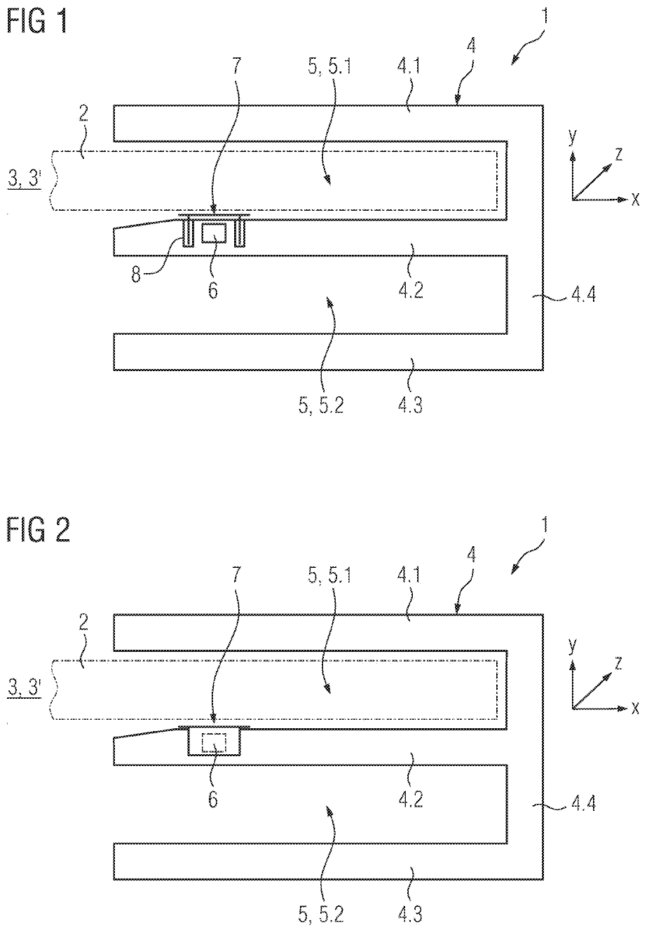

FIGS. 1 and 2 each show a principle representation of a device for determining the temperature of an object according to an exemplary embodiment; and

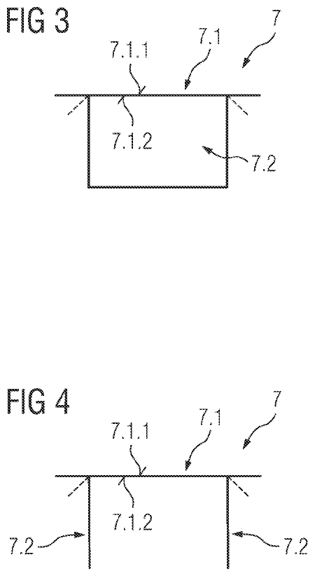

FIGS. 3 and 4 show a principle representation of a contact element according to an exemplary embodiment.

FIG. 1 shows a principle representation of a device 1 for determining the temperature of an object 2 according to a first exemplary embodiment in a sectional view.

The device 1 is configured to determine the temperature of an object 2 and can accordingly also be referred to as or considered to be a sensor arrangement, i.e. in particular a temperature sensor arrangement.

The object 2, which may also be called or considered to be a measuring component and for which the temperature is to be measured by means of the device 1, is formed of or comprises a thermally conductive material, such as a metal, or a thermally conductive material structure, such as a metal structure. In the exemplary embodiment, the object 2 has a rod-like or rod-shaped geometric-constructive form. The object 2 may therefore be a rod made of metal.

The object 2 can be or is thermally coupleable or coupled to a heat source 3, which is indicated merely schematically, via which the object 2 is temperature-controllable or temperature-controlled. The temperature of the object 2 is thus determined in essence by the amount of heat introducible into the object 2 via the heat source 3 thermally couplable or coupled to the object 2. The heat source 3 can vary depending on the application of the device 1. For a conceivable application of the device 1 in a vehicle, i.e. in particular in a motor vehicle, such as a passenger car, the heat source 3 can be a heat source on the (motor) vehicle side.

The object 2 may alternatively or additionally be coupleable or coupled to a purely schematically indicated current and/or voltage source 3′. In particular, the object 2 may be coupleable or coupled to a high-voltage source; thus, a high voltage, i.e. in particular a voltage above 1 kV, can be applied to the object 2. For the example of an application of the device 1 in a vehicle, i.e. in particular in a motor vehicle, such as a passenger car, the current and/or voltage source 3′ may be a current and/or voltage source on the (motor) vehicle side.

The heat source 3 may be identical to the current and/or voltage source 3′, and vice versa.

The device 1 comprises a main body 4. The main body 4 may also be referred to or considered as the housing part of the device 1. The main body 4 has one or more walls 4.1-4.n or is defined by one or more walls 4.1-4.n. The one or more walls 4.1-4.n delimit an interior space 5 for receiving a device 1. The one or more walls 4.1-4.n delimit an interior space 5 for receiving a corresponding object 2. The main body 4 can have, for example, a hollow-cylinder-like or hollow-cylinder-shaped basic geometric form. The geometric-constructive properties, i.e. in particular dimensions, shape, etc., of the interior space 5 are typically adapted to the geometric-constructive properties, i.e. in particular dimensions, shape, etc., of the object 2 that is to be received or is received therein, so that an object 2 is receivable as accurately as possible in the interior space 5. A corresponding object 2 is receivable or received in the interior space 5 with a certain amount of play, in particular due to high manufacturing tolerances.

The main body 4 of the device is typically an injection-moulded part. The main body 4 is therefore typically formed from an injection-mouldable or injection-moulded plastics material. In particular, injection-mouldable plastics materials with a high electrical and/or thermal stability, i.e. in particular high-performance plastic materials, come into consideration. Only by way of example, reference is made to polyamide-imide (PAI), polyetheretherketone (PEEK), polyphenylene sulphide (PPS), polyphenylsulphone (PPSU), polyimide (PI), or polyphthalamide (PPA). Mixtures of chemically different plastics materials are conceivable.

If the device 1 is a particularly small component assembly, such as a precision component assembly, the main body 4 may be a micro-injection-moulded part.

In the exemplary embodiment according to FIG. 1, a web-like or web-shaped wall 4.2 of the main body 4 divides the interior space 5 into two interior space regions 5.1, 5.2. The wall 4.2 extends from a wall 4.4 forming a base of the main body 4 into the interior space 5; the interior space 5 is thus divided by the wall 4.2. The object 2 is received in the interior space region 5.1 merely by way of example.

In the exemplary embodiment according to FIG. 1, the wall 4.2 is provided with a ramp-like or ramp-shaped design (optional) at least on one side in the region of its free end. In this way, for example, an easy insertion of an object 2 to be received in the interior space into the interior space 5 can be realised.

A determination element 6 configured to determine a temperature is arranged or formed within the wall 4.2. The wall 4.2 is therefore provided with a determination element 6 configured to determine a temperature. It is evident that the determination element 6 is surrounded or enclosed by the material forming the wall 4.2. This may be realised, for example, by the fact that the determination element 6 is over-moulded with a material forming the wall 4.2 or is arranged or formed in a receiving space (not shown) provided for this purpose within the wall.

The determination element 6 is formed as or comprises a temperature sensor. The temperature sensor may, for example, be formed as or may comprise a thermistor. The thermistor may, for example, be formed as an NTC element (negative temperature coefficient thermistor) or may comprise such an element.

The device 1 comprises a thermally conductive contact element 7 which can be brought or is brought into thermal contact with an object 2 which is receivable or is received in the interior space 5. It can be seen from FIG. 1 that the contact element 7 is arranged on the wall 4.2, i.e. on the wall within which the determination element 6 is arranged or formed. The contact element 7 is thus arranged or formed, in particular from a thermal point of view, between an object 2 that is receivable or is received in the interior space 5 and the contact element 7 arranged or formed within the wall 4.2. The contact element 7 thus allows an improved heat transfer between an object 2 that is receivable or is received in the interior space 5 and the determination element 6 which is arranged or formed within the wall 4.2. The contact element 7 thus forms a thermal bridge between an object 2 that is receivable or is received in the interior space 5 and the determination element 6 which is arranged or formed within the wall 4.2, so that, although there is no direct contact between the object 2 and the determination element 6 arranged or formed within the wall 4.2, the heat transfer between the object 2 and the determination element 6 arranged or formed within the wall 4.2 is (considerably) improved.

The contact element 7 is formed from or comprises a thermally conductive metal, such as copper. Alternatively or additionally, the contact element 7 may be formed of or may comprise a thermally conductive metal structure, such as a copper structure. In principle, designs of the contact element 7 made of other thermally conductive materials or material structures are also conceivable; for example, reference can be made to plastics materials filled with thermally conductive particles, such as graphite particles.

It can be seen from Fig. that the contact element 7 is arranged or formed on the wall 4.2 adjacently to the determination element 6 arranged or formed within the wall 4.2. This adjacent arrangement allows good heat transfer from the contact element 7 to the determination element 6. It is also apparent from Fig. that, depending on the arrangement and/or orientation of the main body 4 or of the contact element 7, an adjacent arrangement can be understood to mean, for example, a lateral arrangement and/or orientation of the contact element 7 relative to the determination element 6, an arrangement and/or orientation of the contact element 7 above the determination element 6 or an arrangement and/or orientation of the contact element 7 below the determination element 6.

It can be seen from Fig. that there is no direct contact between the object 2 and the determination element 6 and also no direct contact between the contact element 7 and the determination element 6. The determination element 6, due to its arrangement or formation within the wall 4.2, is electrically insulated with respect to the contact element 7. The arrangement or design of the determination element 6 within the wall 4.2 therefore electrically insulates the determination element 6 with respect to the contact element 7, so that any electrical currents and/or voltages present at the contact element 7 cannot be transmitted to the determination element 6. The electrical insulation of the determination element 6 with respect to the contact element 7 can be configured for voltage ranges above 500 V, in particular above 1 kV.

The contact element 7 can be movably mounted on or in the wall 4.2 in at least one degree of freedom of movement. The arrangement or formation of the contact element 7, which is movably mounted in at least one degree of freedom of movement, can serve, for example, to compensate for manufacturing tolerances of the object 2 to be received or received in the interior space 5 and/or to facilitate the insertion of an object 2 to be received in the interior space 5 into the interior space 5. Moreover, the arrangement or formation of the contact element 7, which is movably mounted in at least one degree of freedom of movement, typically allows contact between the contact element 7 and an object 2 received in the interior space 5 to be made over as large an area as possible; this is particularly the case because the orientation and/or position of the contact element 7 can be adapted to the orientation and/or position of an object 2 to be received or received in the interior space 5 on account of its movable mounting.

A corresponding degree of freedom of movement of the contact element 7 can be, in principle, a translatory and/or a rotatory degree of freedom of movement. The contact element 7 may therefore be moved translationally by a certain amount, in particular relative to a reference orientation and/or position of the contact element 7, along a translation axis, such as the x-, y- or z-axis of the coordinate system by way of example shown in FIG. 1 and/or rotationally by a certain amount, in particular relative to a reference orientation and/or position of the contact element 7, about a rotation axis, such as the x-, y- or z-axis of the coordinate system shown by way of example in FIG. 1. In a specific embodiment, the contact element 7 can be tilted or swivelled, for example by a certain amount about a tilting or swivelling axis, such as the z-axis.

An exemplary embodiment of the contact element 7 is shown in more detail in FIGS. 3 and 4, wherein FIG. 3 shows a first side view of the contact element 7 and FIG. 4 shows a side view of the contact element 7 rotated through 90° with respect thereto.

It can be seen from FIGS. 3 and 4 that the contact element 7 may have a first surface portion 7.1, which has at least one flat or planar, i.e. not curved or arched, first surface 7.1.1. The first surface 7.1.1 of the first surface portion 7.1 has a plate-like or plate-shaped basic geometric form. The first surface portion 7.1 thus allows the contact element 7 to lie flat against an object 2 received in the interior space 5 and thus allows a good heat transfer from the object 2 to the contact element 7. In the operating state of the device 1, in which an object 2 is received in the interior space 5, the first surface 71.1 faces the object 2 received in the interior space 5. The first surface 7.1.1 can, for example, be oriented parallel to an exposed outer wall of the main body 4.

The dashed lines in FIGS. 3 and 4 schematically indicate that the first surface portion 7.1. does not have to be completely flat or planar, i.e. it may also have sloped portions running at an angle to the first surface 7.1.1.

In principle, the contact element 7 may have a first surface portion 7.1, which has at least one first surface 7.1.1 with a geometry corresponding to an outer geometry of an object 2 that is to be received or is received in the receiving space 5 and thus allows the contact element 7 to lie flat against an object 2 that is to be received or is received in the interior space 5 and thus allows a good heat transfer from the object 2 to the contact element 7.

It is evident that the first surface portion 7.1 also has, arranged opposite the first surface 7.1.1, a second surface 7.1.2, which faces away from the object 2 received in the interior space 5 and faces the determination element 6 in the operating state of the device 1.

The second surface 7.1.2—as shown by way of example in the exemplary embodiments according to FIGS. 1 and 2—may be equally flat or planar, i.e. not curved or arched; however, this is not mandatory, and therefore—regardless of the flat or planar design of the first surface 7.1.1—an at least partially curved or arched design of the second surface 7.1.2 is conceivable.

In the operating state of the device 1, the first surface portion 7.1 may thus form, with the second surface 7.1.2 facing the wall 4.2 within which the determination element 6 is arranged or formed, a support or contact region, in particular one-dimensional or multidimensional, i.e. in particular linear or laminar, for supporting the contact element 7 on the wall 4.2 or for contacting the contact element 7 with the wall 4.2.

It can also be seen from FIGS. 3 and 4 that the contact element 7 can have further surface portions 7.2 running at an angle, in particular at right angles, to the first surface portion 7.1. In the exemplary embodiment, the further surface portions 7.2 are arranged or formed parallel to one another. The contact element 7 can therefore—viewed in cross-section—have a U-like or U-shaped basic geometric form. The contact element 7 thus represents a three-dimensional component extending in several different spatial directions.

The other surface portions 7.2 can—as shown by way of example in FIGS. 3 and 4—each have a web-like or web-shaped basic geometric form; however, ring-like or ring-shaped basic geometric forms are also conceivable.

The various further surface portions 7.2 each form a fastening region for fastening the contact element 7 to the wall 4.2 within which the determination element 6 is arranged or formed. The function of a further surface portion 7.2 is therefore a fastening function which allows the contact element 7 to be fastened to the wall 4.2. Depending on the geometric-constructive design of the further surface portion 4.2, form-fitting and/or frictionally engaged and/or integrally bonded fastenings of the contact element 7 to the wall 4.2 are possible; specifically, a further surface portion 7.2 can be provided, for example with form-fit and/or frictional engagement elements which allow a form-fitting and/or frictionally engaged fastening of the contact element 7 to the wall 4.2. Corresponding form-fit and/or frictional engagement elements can, for example, be or include undercut, latching or snap-in elements, threaded elements, etc.

Accordingly, in the exemplary embodiment according to FIG. 1, recess-like or recess-shaped receiving regions 8 are arranged or formed in the wall 4.2, within which the determination element 6 is arranged or formed, for receiving respective further surface portions 7.2. The contact element 7 is thus fastened here at least in portions in the wall 4.2. The receiving regions 8 can equally form or comprise a fastening region which cooperates with a corresponding further surface portion 7.2 received therein, forming a fastening of the contact element 7 to the wall 4.2. Correspondingly, respective receiving regions 8 can be provided, for example, with form-fit and/or frictional engagement elements which allow a form-fitting and/or frictionally engaged fastening of the contact element 7 to the wall 4.2. Corresponding form-fit and/or frictional engagement elements can, for example, be or comprise undercut, latching or snap-in elements, threaded elements, etc.

The further surface portions 7.2 can be dimensioned, in particular with regard to their longitudinal extension, in such a way that they surround or engage around the determination element 6 arranged or formed within the wall 4.2 at least in portions. Correspondingly, respective receiving regions 8, in particular with regard to their longitudinal extension, in the wall 4.2 may be dimensioned in such a way that a further surface portion 7.2 received therein surrounds or engages around the determination element 6 arranged or formed within the wall 4.2, at least in portions. The determination element 6 may thus be surrounded or engaged around by the contact element 7 from at least two sides, i.e. on the one hand via the first surface portion 7.1 and on the other hand via the further surface portions 7.2. In this way, it is possible that heat transmitted to the contact element 7 via an object 2 received in the interior space can be transmitted to the determination element 6 not only via the first surface portion 7.1, but also via the further surface portions 7.2 surrounding or engaging around the determination element 6, in particular laterally.

FIG. 2 shows a principle representation of a device 1 for determining the temperature of an object 2 according to a further exemplary embodiment in a sectional view.

The exemplary embodiment shown in FIG. 2 differs from the exemplary embodiment shown in FIG. 1 in the way the contact element 7 is fastened to the wall 4.2 within which the determination element 6 is arranged or formed. In the exemplary embodiment shown in FIG. 2, the contact element 7 is fastened to the wall 4.2. The wall 4.2 is not provided here with receiving regions 8. The contact element 7, i.e. in particular the further surface portions 4.2, engages around the wall 4.2 on the outside at least in portions. The contact element 7 can therefore be latched onto the wall 4.2, for example.

It is true for all exemplary embodiments that the device may comprise an evaluation device (not shown) implemented in terms of hardware and/or software for evaluating signals supplied by the determination element 6 with regard to at least one evaluation criterion. The evaluation device may in particular be configured to evaluate corresponding signals supplied by the determination element 6 with regard to the temperature of an object 2 received in the interior space 5. The evaluation device is connectable or connected to the determination element 6 in terms of signals, so that signals supplied by the determination element 6 can be transmitted to the evaluation device.

The device 1 can be produced by a method comprising the following steps:
forming or providing a main body 4 with an interior space 5 delimited by walls 4.1-4.n for receiving an object 2, the temperature of which is to be determined, wherein at least one determination element 6 configured for determining the temperature is arranged or formed within at least one wall 4.2,
arranging or forming at least one thermally conductive contact element 7, which can be brought into thermal contact with an object 2 received in the interior space 5, on or in the wall 4.2 within which the determination element 6 is arranged or formed.

1. A device for determining the temperature of an object, comprising a main body with an interior space delimited by walls for receiving an object, the temperature of which is to be determined, wherein at least one determination element configured to determine the temperature is arranged or formed within at least one wall, and wherein at least one thermally conductive contact element is arranged or formed on or in the wall within which the determination element is arranged or formed.

2. The device according to claim 1, wherein the determination element is electrically insulated with respect to the contact element, in particular due to its arrangement or formation in the wall.

3. The device according to claim 1, wherein the contact element is arranged or formed on the wall adjacently to the determination element arranged or formed within the wall.

4. The device according to claim 1, wherein the contact element, in particular to compensate for manufacturing tolerances of an object that is received in the interior space, is arranged or formed movably mounted in at least one degree of freedom of movement on or in the wall within which the determination element is arranged or formed.

5. The device according to claim 1, wherein the contact element has a first surface portion which has at least one flat surface.

6. The device according to claim 5, wherein, in the operating state of the device, the first surface portion forms, with a side facing the wall, a support region, in particular a linear or laminar support region, for supporting the contact element on the wall.

7. The device according to claim 5, wherein the contact element comprises at least one further surface portion running at an angle, in particular at right angles, to the first surface portion.

8. The device according to claim 1, wherein the at least one further surface portion forms a fastening region for fastening the contact element to or in the wall.

9. The device according to claim 7, wherein at least one, in particular recess-like or recess-shaped, receiving region for receiving the at least one further surface portion is arranged or formed in the wall.

10. The device according to claim 7, wherein the at least one further surface portion is dimensioned, in particular with regard to its longitudinal extension, in such a way that it at least in portions surrounds the determination element.

11. The device according to claim 1, wherein the contact element is formed of or comprises a thermally conductive metal or is formed of or comprises a thermally conductive metal structure.

12. The device according to claim 1, wherein the main body is formed from an injection-mouldable or injection-moulded plastics material.

13. The device according to claim 12, wherein the plastics material has a high electrical and/or thermal stability.

14. The device according to claim 1, further comprising an evaluation device for evaluating signals supplied by the determination element with regard to at least one evaluation criterion.

15. A vehicle, in particular a motor vehicle, including a device according to claim 1.

16. A method for producing a device for determining the temperature of an object, the method comprising:
forming or providing a main body with an interior space delimited by walls for receiving the object, wherein at least one determination element configured for determining the temperature is arranged or formed within at least one wall, and
arranging or forming at least one thermally conductive contact element on or in the wall within which the determination element is arranged or formed.
